(19) United States
(12) Patent Application Publication
(10) Pub. No.: US 2026/0326823 A1
(43) Pub. Date: Oct. 22, 2026

(54) ROCKER ASSEMBLIES FOR A VEHICLE AND MANUFACTURING METHODS

(71) Applicant: AUTOTECH ENGINEERING S.L., Amorebieta-Etxano (ES)

(72) Inventors: Diego ARGOTE QUINTANA, Vitoria-Gasteiz (Álava) (ES); Iker BOLLEGI ZULOAGA, Abadiño (Bizkaia) (ES); Alexander Rafael SABINO URBIETA, Sopela (Bizkaia) (ES)

(21) Appl. No.: 19/112,231

(22) PCT Filed: Sep. 29, 2023
(86) PCT No.: PCT/EP2023/077168

§ 371 Date: Mar. 14, 2025

(30) Foreign Application Priority Data
Sep. 30, 2022 (EP) 22382910.2

(51) Int. Cl. B62D 21/15; B60K 1/04; B60N 2/015; B62D 25/02; B62D 29/00

(52) U.S. Cl. CPC B62D 21/157; B60K 1/04; B60N 2/015; B62D 25/025; B62D 29/007; B62D 29/008; B60K 2001/0438

(57) ABSTRACT

The present disclosure relates to a rocker assembly (10) for a vehicle comprising a rocker (20) and a rocker reinforcement (30) inside the rocker. The present disclosure further relates to a method (100) for manufacturing a rocker assembly for a vehicle. A rocker assembly (10) for a vehicle comprises a rocker (20) including an outer panel (11) and an inner panel (12), and an elongated reinforcement (30) inside the rocker extending along a longitudinal direction (40) of the rocker. The reinforcement (30) comprises an outer portion (31) configured to absorb energy during a side impact and an inner portion (32) configured to deviate side impact loads above and under the batteries of the vehicle.

### TECHNICAL FIELD

The present application claims the benefit of European patent application no 22 382 910.2 filed on Sep. 30, 2022.

The present disclosure relates to a rocker assembly for a vehicle comprising a rocker and a rocker reinforcement inside the rocker. The present disclosure further relates to a method for manufacturing a rocker assembly for a vehicle. The present disclosure relates specifically to rockers, and rocker reinforcements for electric vehicles or hybrid vehicles.

### BACKGROUND

Vehicles such as cars incorporate a structural skeleton designed to withstand all loads that the vehicle may be subjected to during its lifetime. The structural skeleton or “Body In White” (BIW) is further designed to withstand and absorb impacts, in case of e.g. collisions with other cars. The structural skeleton is also designed to be as lightweight as possible in order to reduce the emission of pollutants such as CO₂ to the environment or to reduce the consumption of electricity in an electric vehicle.

The structural skeleton or BIW of a car may for instance include bumpers, pillars (e.g. A-pillar, B-pillar, C-pillar), side impact beams and rocker panels. These and other structural members may have one or more regions with a substantially U-shaped (also known as “hat”-shaped) cross section. These structural members may be manufactured in a variety of ways and may be made of a variety of materials. For instance, rocker panels may be made of steel, particularly Ultra-High Strength Steels (UHSS) and may be manufactured through press hardening.

Ultra-High Strength Steels (UHSS) exhibit optimized maximum strength per weight unit and advantageous forming properties in the automotive industry, for the structural framework of the vehicle or at least a number of its components. In the present disclosure, an UHSS may be regarded as a steel with a maximum tensile strength (after hot stamping) of at least 1000 MPa, preferably up to about 1500 MPa or up to 2000 MPa or more. An example of an UHSS used in the automotive industry is 22MnB5 steel.

Processing a component for a vehicle may comprise forming of a metal plate, in particular a steel plate, in order to give the plate a desired shape. One process that is used particularly in the automotive industry is Hot Forming Die Quenching (HFDQ). In the HFDQ process, a steel blank is heated to above an austenization temperature, above Ac1 or above Ac3. After heating to above the austenization temperature, the blanks are placed in a hot forming press. The blanks are deformed and at the same time are quenched (rapidly cooled down). Cooling down may typically occur at a rate that is higher than a so-called critical cooling rate. The critical cooling rate for steels in HFDQ may be around 27° C./s. As a result of the quenching, the deformed blank may obtain a martensitic microstructure. Depending on the exact temperature and the heating time, a fully martensitic microstructure can be obtained. The resulting product in this manner can obtain a high hardness, and corresponding high ultimate tensile strength, and high yield strength. On the other hand, maximum elongation (elongation at break) may be relatively low.

Tailored heating or tailored in-die cooling may be used to provide so-called “soft zones”, i.e. areas with higher ductility, and lower ultimate tensile strength and yield strength. The microstructure in these areas may not be fully martensitic due to selective heating (e.g. not all areas of a blank are heated to an austenization temperature) or due to tailored cooling (e.g. not all areas are cooled down with same cooling rate). They may comprise one or more of martensite, bainite, ferrite and perlite depending on the heat treatment they have been subjected to.

Besides tailored heating or cooling, also a partial heat treatment after HFDQ may be used. For example, an induction heater or a laser may be used to locally heat treat an area of the press hardened product. Heating time, maximum temperature and cooling rate may be adapted to obtain desired mechanical properties in terms of ductility, hardness, yield strength etc. and the corresponding microstructure.

A rocker lies along a side of the vehicle, below an opening for the door(s) and extends between a front wheel opening and a rear wheel opening. The rocker is sometimes referred to as “sill”. A rocker generally includes two portions or panels which are joined to each other at corresponding flanges along the longitudinal direction of the rocker (and thus the longitudinal direction of the vehicle too), namely an inner rocker panel and an outer rocker panel. An inner rocker panel faces the vehicle interior whereas an outer rocker panel faces away from the vehicle. Rockers are important for absorbing sufficient energy while avoiding an excessive intrusion of the sides of a vehicle during a crash, especially in a lateral crash. The performance of a rocker, for instance in terms of energy absorption and intrusion, may be tested with e.g. a Euro NCAP's test.

The rapid development of electric vehicles (EVs) and hybrid vehicles has forced the industry to design new car components, e.g. for weight reduction to achieve improved vehicle range, and for accommodating and protecting new car components among others. Structural components with new geometries and alternative materials are being manufactured and integrated into EVs to accomplish safety and weight reduction goals.

Traction batteries are an important part of the EVs and hybrid vehicles which provide power to an electric motor of the vehicle. The electronic and chemical nature of these batteries makes them particularly sensitive to high mechanical loads, e.g. crash impacts. To extend battery lifespan and protect them against external collisions, the automotive industry has put considerable effort to provide battery enclosures and load bearing structures suitable for EVs. Thus, a wide range of protection elements have been designed and engineered during the last years to accommodate and protect traction batteries.

Rockers are useful not only for protecting the passengers in a vehicle, but also for protecting the battery box in electrical vehicles or hybrid vehicles. The battery box is generally arranged at a bottom of the vehicle, extending between the vehicle's front and rear axles. It is configured for supporting and housing the batteries of the vehicle. If the vehicle is involved in a collision, in particular against a lateral side of the vehicle, the rocker may avoid or at least reduce damage to the battery box. The rockers should be able to absorb as much energy as possible in order to maximize battery box protection.

A way to enhance energy absorption while providing an adequate level of deformation of a rocker may be adding a reinforcement to the rocker, e.g. between the inner rocker and the outer rocker panels. Optimizing the materials, geometry and means of attaching a rocker reinforcement to a rocker is important to improve the energy absorption and the integrity of the rocker during a lateral crash while keeping a lightweight piece.

The present disclosure aims to provide improvements in rocker reinforcements.

### SUMMARY

Throughout this disclosure, a longitudinal direction, a vertical direction and a lateral direction are defined for providing spatial orientation of a rocker and a rocker reinforcement attached to the rocker. These directions are substantially perpendicular to each other. Thus, a rocker has a length along the longitudinal direction (the longitudinal direction would be parallel to a driving direction of the vehicle in which the rocker is mounted), a height along the vertical direction and a width along the lateral direction; and a cross-section of the rocker is defined by a plane substantially perpendicular to the longitudinal direction, thus including the vertical direction and the lateral direction. Likewise, a rocker reinforcement has a length along the longitudinal direction, a height along the vertical direction and a width along the lateral direction; and a cross-section of the rocker reinforcement is substantially perpendicular to the longitudinal direction and includes the vertical direction and the lateral direction.

Accordingly, when a rocker receives a side impact and therefore a side impact load, e.g. during a vehicle crash or with a post when on the road, a side impact may be assumed to be substantially along a lateral direction in a standardized crash test. In practice, the impact may at least include a component substantially parallel to the lateral direction.

In a front crash, or SORB (“Small Overlap Rigid Barrier”) test, the impact may be assumed to be substantially along a longitudinal direction in accordance with the above definitions. In the present disclosure, the focus will be primarily on side impacts.

In an aspect of the disclosure, a rocker assembly for a vehicle is provided. The rocker assembly comprises a rocker including an outer panel configured to receive a side impact load and an inner panel configured to transmit the side impact load to an inner structure of the vehicle. The rocker assembly further comprises a reinforcement inside the rocker between the inner panel and the outer panel. The rocker reinforcement extends along a longitudinal direction of the rocker and defines a cell structure in a cross-section perpendicular to the longitudinal direction of the rocker along at least a portion of the rocker. The cell structure comprises a plurality of cells, the cells being formed by one or more walls forming a closed cross-section. The plurality of cells comprises an outer portion and an inner portion, the outer portion being closer to the outer panel and the inner portion being closer to the inner panel. The inner portion comprises an upper inner cell configured to contact the inner panel at a vertical position which is substantially above a battery of the vehicle and a lower inner cell configured to contact the inner panel at a vertical position which is substantially below the battery of the vehicle when the rocker receives the side impact load. The inner portion comprises an empty space between the upper inner cell and the lower inner cell.

According to this aspect, a reinforcement comprising an inner portion, which is to face an inside of a vehicle and which comprises at least two “legs” for deviating loads above and below the batteries of an electrical (totally or partially electrical) vehicle, may be provided inside a rocker. A remaining portion of the reinforcement which is to face an outside of a vehicle, which is referred to as outer portion, is configured to compress and therefore absorb energy during a side impact.

In this way, a sufficient amount of energy may be absorbed at relatively low weight by the deformation of the outer portion of the reinforcement, and loads due to the side impact, e.g. lateral forces, may be deviated away from the vehicle batteries by the reinforcement “legs”. The lower leg may further help to stabilize the deformation of the rocker reinforcement. Battery intrusion and damage may be minimized or at least reduced. Therefore, vehicle damage may be reduced, the need for battery and vehicle repairs may also be reduced, and passenger safety may be increased. As an empty space vertically separates the upper and lower “legs” of the reinforcement, a reasonably low weight of the reinforcement may be kept.

Throughout this disclosure, a cell structure may be understood as a plurality of interconnected cells. Contiguous cells may share a wall or wall portion between them. The walls of a cell may be substantially straight, although in some examples one or more cell walls may be curved. The cells form channels along a longitudinal direction of the reinforcement, and therefore of the rocker.

The outer portion of the cell structure may comprise at least one cell which is hexagonal in cross-section in some examples. The outer portion may comprise, e.g. may be, a honeycomb structure. Hexagonal cross-sectional cells may help to enhance energy absorption. The cells of the outer portion may be oriented such that at least one cell wall of one or more cells is, in cross-section, substantially parallel to the lateral direction. For example, a honeycomb outer portion with its cells oriented such that one diagonal of the corresponding hexagonal cells in cross-section which connects two opposite vertices of the cells is substantially parallel to the lateral direction may contribute to increase the energy absorbed by the outer portion of the rocker reinforcement.

In some examples, the upper inner cell is elongated and is configured to deviate the side impact load, e.g. a portion of the side impact load, towards a floor of the vehicle (because the upper inner cell is elongated towards a floor of the vehicle when the rocker assembly is mounted in the vehicle). In some of these examples, the cell structure may further comprise a top inner cell above the upper inner cell which is elongated and is configured to deviate impact loads towards a seat cross-member of the vehicle (because the top inner cell is elongated towards a seat cross-member of the vehicle when the rocker assembly is mounted in the vehicle). Loads, e.g. forces, may thus be deviated towards sturdy vehicle elements instead than towards a battery box or batteries, reducing battery damage and increasing passenger safety.

In order to optimize energy absorption and controlled deformation of the rocker reinforcement at a given weight, one or more of the following features may be used by themselves or in combination in some examples: a maximum length in cross-section of the upper inner cell and a maximum length in cross-section of the lower inner cell may be between one third and two thirds of a maximum width of the rocker reinforcement, e.g. between 40% and 60%, optionally about 50% of the maximum width of the rocker reinforcement; and the upper inner cell, the lower inner cell and one or more cells vertically connecting the upper and lower inner cells may form an arc-shape in cross-section.

In some examples, a mean thickness of the lower and upper inner cells may be higher than a mean thickness of the outer portion of the rocker reinforcement. Similarly to the two features above, such a thickness relation may help to increase energy absorption and to effectively deviate side impact loads away from the vehicle batteries.

At least a portion of the perimeter of the outer portion of the rocker reinforcement may follow a shape of the outer rocker panel in cross-section in some examples. An outer portion of the reinforcement having an outer shape adapted to the shape of the outer rocker panel may help to increase the energy absorbed in a crash while optimizing the space available inside the rocker. The perimetral walls of the outer portion, e.g. a portion of the perimeter of the outer portion substantially parallel to the rocker outer panel, may also help to support the rocker during a side impact, which may reduce rocker deformation and intrusion while still having a high absorption of energy. The perimetral cell walls, i.e. the cell walls or wall portions belonging to the perimeter of the rocker reinforcement, which follow a portion of an outer rocker panel provide a surface for receiving an impact from the outer rocker panel and can help to provide stability in the deformation during a side crash.

In some examples, a maximum width of the rocker in cross-section may be of 120 mm or more. Such a rocker may be known as “wide rocker”. A wide rocker may particularly benefit from having a reinforcement as disclosed herein for optimizing the energy absorbed during a side impact with reduced weight of the reinforcement and while decreasing battery damage.

In some examples, the reinforcement may be an extruded profile, e.g. of an aluminum alloy. In other examples, a profile may be formed with roll-forming. Extrusion may be regarded as more suitable for profiles with a closed cross-section.

In some examples, the reinforcement is made of extruded aluminum. This may reduce the weight of the rocker reinforcement. Herein, aluminum may cover aluminum and its alloys. Particularly aluminum 6XXX and 7XXX (“6000” and “7000” series) may be used.

In some examples, the inner panel and the outer panel of the rocker may be made of an ultra-high strength steel, specifically a press hardened ultra-high strength steel, e.g. a boron steel. A combination of lightweight aluminum for absorbing energy and UHSS for strength can lead to a good combination of energy absorption and impact resistance.

In a further aspect, an electric or hybrid vehicle is provided comprising a rocker assembly according to any of the examples herein described.

In a further aspect, a method for manufacturing a rocker assembly for a vehicle is provided. The method comprises: providing an inner rocker panel and an outer rocker panel; providing an aluminum rocker reinforcement with a cross-section according to any of the examples throughout this disclosure; and mechanically attaching the rocker reinforcement to the inner rocker panel and the outer rocker panel such that the upper inner cell contacts the inner rocker panel at a vertical position which is substantially above a battery of the vehicle and the lower inner cell contacts the inner rocker panel at a vertical position which is substantially below a battery of the vehicle when the rocker receives a side impact load.

This method enables providing enhanced energy absorption while minimizing battery damage in a side crash. Passenger safety may also be increased.

### BRIEF DESCRIPTION OF THE DRAWINGS

Non-limiting examples of the present disclosure will be described in the following, with reference to the appended figures, in which:

FIG. 1 schematically illustrates a perspective view of an example of a rocker assembly.

FIG. 2 schematically illustrates a cross-section of the rocker assembly of FIG. 1.

FIG. 3 schematically illustrates an example of the cross-section of the rocker assembly of FIG. 2 arranged besides a bottom of a vehicle.

FIG. 4 schematically illustrates an example of the cross-section of the reinforcement of FIG. 2 after a side impact.

FIGS. 5 and 6 schematically illustrate cross-sections of two examples of rocker assemblies of the prior art.

FIG. 7 illustrates a flow chart of an example of a method for manufacturing a rocker assembly.

The figures refer to example implementations and are only be used as an aid for understanding the claimed subject matter, not for limiting it in any sense.

### DETAILED DESCRIPTION OF EXAMPLES

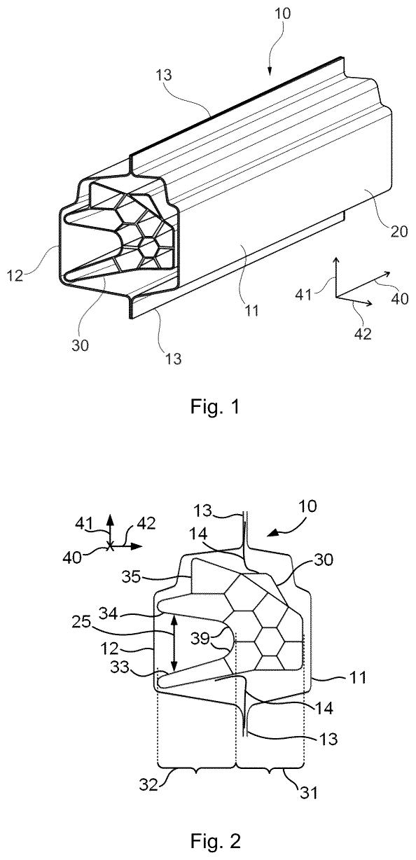

FIG. 1 schematically represents a rocker assembly 10 for a vehicle, e.g. a car. A longitudinal direction 40, a vertical direction 41 and a lateral direction 42 as used throughout this disclosure and as hereinbefore defined are depicted. These directions are substantially perpendicular to each other.

The rocker assembly 10 comprises a rocker 20 and an elongated reinforcement 30 inside the rocker. The reinforcement 30 extends along a longitudinal direction 40 of the rocker 20. The rocker 20 comprises an outer panel 11 and an inner panel 12, and the rocker reinforcement 30 is between the inner panel 12 and the outer panel 11. When mounted to a vehicle, the inner panel 12 of the rocker 20 would be facing an inside of the vehicle whereas the outer panel 11 would be facing an outside of the vehicle. I.e., the outer panel 11 is configured to receive side impact loads and the inner panel 12 is configured to transmit side impact loads to an inner structure of the vehicle.

The rocker 20 and the rocker reinforcement 30 have a length along a longitudinal direction 40 and a cross-section substantially perpendicular to the longitudinal direction 40. A cross-section is defined by a plane including two directions, namely the vertical direction 41 and the lateral direction 42 (or a plane parallel to these directions).

The longitudinal direction 40 of both the rocker 20 and the rocker reinforcement 30 also corresponds to the longitudinal direction of a vehicle to which the rocker 20 with the rocker reinforcement 30 may be mounted.

In some examples, the length of the rocker reinforcement 30 may be substantially equal to the length of the rocker 20. In some other examples, the length of the rocker reinforcement 30 may be less than the length of the rocker 20, e.g. the reinforcement may have a length of at least 25%, or at least 50%, or at least 75% of a length of the rocker in which it is incorporated. A rocker 20 may include one or more rocker reinforcements 30.

The outer panel 11 and the inner panel 12 of the rocker 20 may be made of an ultra-high strength steel (UHSS), in particular a press hardened ultra-high strength steel, e.g. a boron steel. UHSS exhibits an optimized maximum strength per weight unit and advantageous formability properties. UHSS may exhibit ultimate tensile strength of as high as 1500 MPa, or even 2000 MPa or more, particularly after a press hardening operation. In such an operation, a steel blank is heated to above an austenization temperature, in particular to above Ac3 to substantially fully austenize the blank. After heating to above this temperature for a period of time, the blank is subjected to a pressing operation in which the blank is deformed. At the same time, the blank is rapidly cooled such that the blank is substantially “fully hardened”, and a martensitic microstructure is obtained. Examples of hardened steel include UHSS such as 22MnB5 steel or Usibor® 1500, Usibor® being commercially available from Arcelor Mittal. Another example of a hardenable boron steel is 37MnB5, or Usibor® 2000.

The composition of Usibor® 1500 is summarized below in weight percentages (rest is iron (Fe) and impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35

Usibor® 1500 may have a yield strength of e.g. 1100 MPa, and an ultimate tensile strength of 1500 MPa.

Usibor® 2000 is another boron steel with even higher strength. The yield strength of Usibor® 2000 may be 1400 MPa or more, and the ultimate tensile strength may be above 1800 MPa. The composition of Usibor® 2000 is summarized below in weight percentages (rest is iron (Fe) and impurities):
Maximum carbon (C) (%): 0.36
Maximum silicon (Si) (%): 0.8
Maximum manganese (Mn) (%): 0.8
Maximum phosphorus (P) (%): 0.03
Maximum sulphur(S) (%): 0.01
Aluminium (Al) (%): 0.01-0.06
Maximum titanium (Ti) (%): 0.07
Maximum niobium (Nb) (%): 0.07
Maximum copper (Cu) (%): 0.20
Maximum boron (B) (%): 0.005
Maximum chromium (Cr) (%): 0.50
Maximum molybdenum (Mb) (%): 0.50

A lower portion and an upper portion of the outer 11 and inner 12 panels may include mounting flanges 13 for attaching the panels to each other, and also to other parts of the vehicle frame.

The reinforcement 30 may be made of an extruded profile, e.g. of an aluminum alloy, in some examples. Extruded profiles are specifically suitable when a long reinforcement is required. In other examples, a rocker reinforcement may be roll-formed. Suitable aluminum alloys include the aluminum 6000 series or aluminum 7000 series. Suitable aluminum alloys include e.g. 6005, 6060, 6061, 6063, 6082 and 6106.

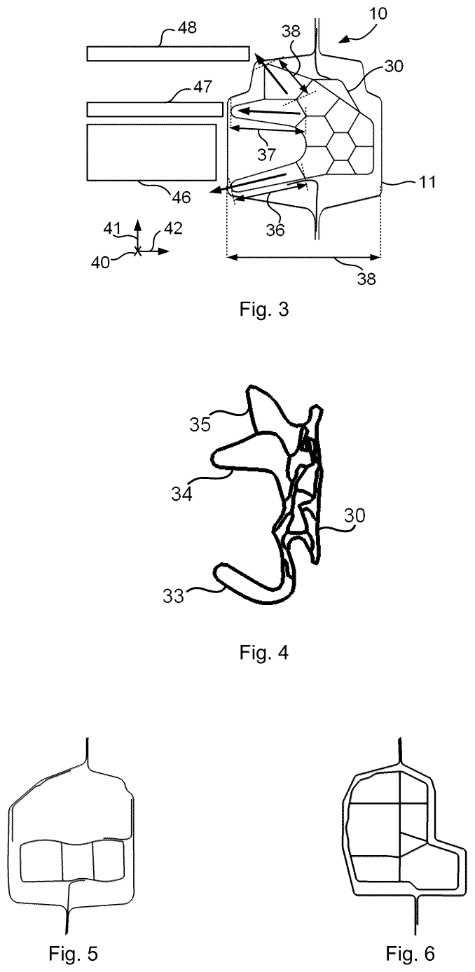

Using aluminum can reduce the weight of the rocker reinforcement 30, and thus the weight of the rocker assembly 10 and of a vehicle to which the rocker assembly may be mounted. The use of aluminum also facilitates the obtention of a rocker reinforcement 30 with a cross-section like the cross-section shown in FIGS. 2 and 3 by extrusion. Adapting the thickness(es) and shape(s) in cross-section of a rocker reinforcement 30 may also be easier with the use of aluminum and extrusion. A length of an extruded rocker reinforcement 30 may likewise be easily tailored. In some examples, a length of a rocker reinforcement 30 may be between 1 and 1.5 m. The length of the rocker reinforcement may vary in particular as a function of the length of the rocker, but the geometry and space available inside the rocker may also play a role.

A combination of lightweight aluminum for absorbing energy and UHSS for strength can lead to a good combination of energy absorption and impact resistance.

FIG. 2 schematically illustrates an example of a cross-section of the rocker assembly 10 of FIG. 1. The rocker reinforcement 30 defines, e.g. is made of, a cell structure perpendicular to the longitudinal direction 40 of the rocker 20 along at least a portion of the rocker 20. The cell structure comprises a plurality of cells, the cells being formed by one or more walls forming a closed cross-section. I.e. each of the cells is formed by one or more walls forming a closed cross-section.

The plurality of cells, and therefore the rocker reinforcement, comprises an inner portion 32 and an outer portion 31. The inner portion 32 comprises an upper inner cell 34 configured to contact the inner rocker panel 12 at a vertical position which is substantially above a battery of the vehicle when the rocker receives a side impact load. The inner portion 32 further comprises a lower inner cell 33 configured to contact the inner rocker panel 12 at a vertical position which is substantially below the battery of the vehicle. The inner portion 32 comprises an empty space 25 between the upper inner cell 34 and the lower inner cell 33. The empty space 25 may e.g. be a vertical gap which separates the upper inner cell 34 and the lower inner cell 33.

In the example of FIG. 2, a side impact would come from the right hand side of the figure. As the “legs”, i.e. the upper 34 and lower 33 inner cells, are configured to guide a side force compressing the rocker above and below the battery box 46, damage to the battery box and the batteries may be decreased. Intrusion of the rocker assembly in the battery box may be avoided or at least reduced. Contact between the battery box and the rocker may also be avoided or at least reduced.

In some examples, e.g. in the examples of FIGS. 1-3, the lower inner cell 33 is a bottom inner cell 33. In other non-shown examples, there may be one or more cells below the lower inner cell 33. Similarly, in some examples the upper inner cell 34 may be a top inner cell 34 (not shown in FIGS. 1-3).

The inner portion 32 of the cell structure is closer to the inner rocker panel 12 than the outer portion 31. The outer portion 31 is therefore closer to the outer rocker panel 11 than the inner portion 32.

The outer portion 31 of the cell structure may comprise at least one cell which is hexagonal in cross-section. In the example of FIG. 2, a cell comprising a regular hexagon in cross-section is shown. In other examples, the outer portion 31 may comprise a plurality of cells, including all the cells of the outer portion 31, which are regular hexagons in cross-section. A cell comprising a regular hexagon may, in cross-section, comprise walls with a substantially same length and central angles of about 120°. One or more cells of the outer portion 31 may be irregular hexagons in other examples. An irregular hexagon may be understood as a hexagon in which at least one of the following two conditions occur: not all the central angles are about 120°, and not all the walls have a same length. The use of regular hexagons in cross-section may increase the energy absorbed by the rocker reinforcement 30 in comparison to when the cross-section of the hexagonal cells is irregular.

In some examples the outer portion 31 may comprise, e.g. be, a honeycomb structure. A honeycomb-like outer portion may increase an amount of energy absorbed in a side impact with respect to other configurations, e.g. cross-sectional shapes of the cells, of the outer portion 31. The outer portion 31 of the reinforcement 30 of FIGS. 1-3 may be seen as a honeycomb. In other examples, a honeycomb outer portion may comprise more or less cells than the honeycomb outer portion of FIGS. 1-3. A honeycomb-like outer portion 31 may comprise regular and/or irregular hexagons.

In some examples, the cells of the outer portion 31 may be oriented such that at least one wall, e.g. two opposite walls, of one or more cells therein, in cross-section, is substantially parallel to the lateral direction 42. I.e., a top wall and/or a bottom wall of one or more cells of the outer portion 31 may extend along the lateral direction 42 in cross-section. This may be seen in the examples of FIGS. 1-3. This specific orientation of the cells may be particularly suitable for absorbing energy in side impacts where a force, or at least a component of a force, is exerted substantially along a lateral direction 42. This orientation may also increase the absorption of energy in a lateral crash with respect to e.g. where two opposite walls of the cells of the outer portion 31 in cross-section are aligned along a vertical direction 41 or along another direction different from the lateral direction 42.

In this or in other examples, a rocker reinforcement 30 may comprise a cell structure, and in particular an outer portion 31 of the cell structure, such that in cross-section at least one wall, e.g. two opposite walls, of one or more cells, are substantially aligned along a vertical direction 41. In these examples, the walls of a cell extending along a vertical direction 41 in cross-section may be referred to as vertical lateral walls.

Still in any of the two previous examples, or yet in other examples, at least one wall of one or more cells of outer portion 31 of the cell structure, and in general of the entire cell structure, may be substantially parallel, in cross-section, to a direction different from the lateral direction 42 and the vertical direction 41.

FIG. 3 schematically illustrates an example of the cross-section of the rocker assembly 10 of FIG. 2 arranged besides a bottom of a vehicle. In this example, the upper inner cell 34 is elongated, and configured to deviate side impact loads towards a floor 47 of the electric vehicle. The vehicle floor 47 may be made of hot-stamped boron steel in some examples. An arrow over the upper inner cell 34 illustrates the direction of the deviation in FIG. 3. Damage of the batteries and/or a battery box may therefore be avoided or at least reduced, as the impact is deviated above the batteries 46 towards a stiff and/or strong element such as the vehicle floor 47. A battery box may comprise a box made of a steel sheet in some examples. The battery cells, i.e. the batteries, may be placed inside the box. The battery box may include a cooling system, electrical connections, busbars etc. A reinforcement frame may be arranged around the battery box.

Although not shown in the examples of the figures, in other examples the upper inner cell 34 may be elongated, and configured to deviate side impact loads towards a seat cross-member 48 of the vehicle. A seat cross-member 48 is also a resistant element which may stand the loads of a side impact. Also in this case, damage to the batteries 46 may be minimized as the loads are diverted to the seat cross-member 48. A seat cross-member 48 may be a separate component from the vehicle floor 47 in some examples. In other examples, the seat cross-member may be integrated in a vehicle floor 47. A seat cross-member may e.g. be made by hot stamping of boron steel.

In the examples where the upper inner cell 34 is configured to deviate side impact loads to a vehicle floor 47, the cell structure may further comprise a top inner cell 35 above the upper inner cell 34 which is configured to deviate impact loads towards a set cross-member 48 of the vehicle. The top inner cell 35 may be elongated towards a seat cross-member when the rocker assembly 10 is mounted in the vehicle. This particular configuration may further enhance impact deviation away from the battery (box) 46 and energy absorption by other vehicle elements (floor, seat cross-member) sturdier than the battery box.

In some examples, a maximum length in cross-section 37 of the upper inner cell 34 and a maximum length in cross-section 36 of the lower inner cell 33 (and optionally a maximum length in cross-section of the top inner cell 35) may be between one third and two thirds, e.g. between 40% and 60%, e.g. about 50%, of a maximum width of the rocker reinforcement. Such a proportion may help the reinforcement “legs” to deform less than the outer portion 31 of the reinforcement 30, and therefore to provide a suitable and optimized balance between absorbing a high amount of energy by the outer portion 31 of the reinforcement 30 and deviating a high amount of non-absorbed energy away from the batteries 46.

The upper inner cell 34, the lower inner cell 33 and one or more cells 39 vertically connecting the upper 34 and lower 33 inner cells may form an arc-shape in cross-section. For example, these group of cells have a turned around C-shape in the examples of FIGS. 1-3. An empty space 25 between the upper and lower inner cells, e.g. a D-shaped gap, may help to reduce reinforcement weight without compromising energy absorption. An arc-shape of the upper inner cell 34, lower inner cell 33 and connecting cells 39 may help to facilitate diverting the energy away from the vehicle batteries. In other examples, other shapes of the gap and the corresponding cells 33, 34, 39 may be possible.

A width in cross-section of the rocker reinforcement 30 where the curvature of the arch is maximum, i.e. if the perimeter of the rocker reinforcement in the region between the upper 34 and lower 33 inner cells forms and arch, e.g. a turned around C-shape, at a height where the curvature of the arch is maximum; may be between one third and two thirds of the maximum width of the rocker reinforcement. For example, such width in cross-section of the rocker reinforcement may be between 40% and 60%, e.g. about 50%, of the maximum width of the rocker reinforcement 30. This may again help the inner portion 32 to deviate the side impact loads below and above the battery box 46 while the outer portion 31 of the rocker reinforcement 30 may collapse and absorb a reasonably high amount of energy.

Besides a shape and the length and/or width of the “legs” 33, 34, 35 and the outer portion 31 of the reinforcement 30, a thickness of the different cells of the reinforcement 30 may also be tailored to adjust the compression and/or deviation of the impact received by outer rocker panel 11. The thickness of the walls of the cell structure of the reinforcement 30, and in particular of the outer portion 31, may be varied in order to optimize the amount of energy absorbed by the rocker assembly 10 in a side impact. The thickness of different walls of a “leg” may similarly be varied to adapt the direction in which an impact load is deviated away from the batteries 46.

A mean thickness of the cell walls of the rocker reinforcement 30 may vary between 1.5 and 6, e.g. between 2 and 4 mm, in some examples. In some examples, all the walls of the cells of the outer portion 31 of the reinforcement 30 may have substantially the same thickness. In other examples, the walls of the cells of the outer portion 31 of the reinforcement 30 may have different thicknesses from each other. For example, the thickness of the cell walls of the outer portion 31 may vary between 1.5 and 5 mm. E.g. one or more cell walls may have a thickness of 3.2 mm. These thicknesses, in particular for an extruded aluminum rocker reinforcement, may confer a sufficient strength to the reinforcement while maximizing energy absorption for a given weight.

In some examples, a mean, i.e. average, thickness of the rocker reinforcement “legs”, e.g. the lower 33 and upper 34 inner cells, may be higher than a mean thickness of the outer portion 31 of the rocker reinforcement 30. This may facilitate that the outer portion 31 mainly collapses during a side impact, whereas the “legs” do not collapse as much and may deviate loads, e.g. forces, away from the vehicle batteries 46. An example of this situation is represented in FIG. 4.

FIG. 4 schematically illustrates an example of the cross-section of the reinforcement of FIG. 2 after a side impact coming from the right hand side of the image. The outer portion 31 of the rocker reinforcement 30 has been entirely compressed whereas the “legs” 33, 34, 35 have been deformed, but less than the outer portion 31 of the rocker reinforcement 30. It may also be seen in FIG. 4, how the lower and upper inner cells 33, 34 respectively maintain a vertical gap between them thus avoiding or limiting load transmission to a battery (tray) arranged at the inside of the rocker.

In some examples, at least a portion of the outer edge, i.e. the perimeter, of the outer portion 31 of the rocker reinforcement 30 may follow a shape of the outer rocker panel 11 in cross-section. For instance, a top and a side portion of the perimeter of the outer portion 31 follows, in cross-section, a shape of the outer panel 31 in FIGS. 2 and 3. A more efficient use of the space inside the rocker and enhanced energy absorption may be achieved if the perimeter of the outer portion 31 which is configured to receive an impact of the outer panel 11 of the rocker 20 in a side impact follows a shape of the outer rocker panel 11. In some examples, a side portion of the perimeter of the outer portion 31 may be, in cross-section, substantially parallel to the outer rocker panel 11. This may be seen e.g. in the examples of FIGS. 2 and 3.

A maximum width 38 of the rocker 20 in cross-section may be of 120 mm or more in some examples. Such a rocker may be known as “wide rocker”. Due to their cross-sectional dimensions, wide rockers may not be compressed entirely upon a side impact. I.e., only a portion of the rocker closest to a side impact may undergo deformation, and therefore absorb energy. Providing a rocker reinforcement 30 as described herein within a “wide rocker” may be particularly helpful, as the outer portion 31 of the reinforcement would be arranged in the rocker portion mainly undergoing compression, whereas the inner portion 32 with the “legs” 33, 34, 35 would be arranged in the rocker portion which may not compress, or may compress less. The outer portion 31 may help to enhance the energy absorbed, while damage to the batteries 46 may be prevented or reduced due to the “legs” 33, 34, 35 deviating forces away from the batteries, and all this without adding unnecessary mass and weight in the inner portion 32. An optimized and efficient rocker assembly 10 may be obtained.

A maximum width of the rocker reinforcement 30 may be similar to, but less than, a maximum width of the rocker 20. In some examples, the reinforcement 30 may touch a surface of the inner and/or outer panels of the rocker at least at some regions along the longitudinal direction 40.

The rocker 20 and the rocker reinforcement 30 may be attached to one another through one of more fasteners 14. In FIG. 2, the fastener 14 comprise two strips, e.g. steel strips. The steel strips may be made of a high-strength steel, specifically of a high-strength low-alloy steel. In an example, HSLA420 as commercialized by ArcelorMittal may be used. Similar steels may include Docol® 420LA. “420” as used in these examples indicates a minimum yield strength for the steels. Alternative steels may also be used.

An end of the strip may be joined to a mounting flange 13 of the outer 11 and/or inner 12 rocker panels. Another end may be joined to the reinforcement 30, e.g. to a bottom or a top of the reinforcement. The examples of FIG. 2 show that a top strip is joined to a top of the reinforcement 30 whereas a bottom strip is joined to a bottom of the reinforcement 30. Attachment of a strip 14 to the reinforcement and/or a mounting flange 13 may be through a screw or a rivet in some examples. This kind of fastener may be particularly suitable for joining a central portion of the rocker reinforcement 30 to the rocker 20, but it may also be used to attach one or both longitudinal ends of the reinforcement 30 to the rocker 20.

Other possible way of attaching the reinforcement 30 and the rocker 20, in particular a longitudinal end of the reinforcement 30, may be by joining an end of a strip, e.g. a steel strip, to an inner portion of the inner 12 or outer 11 rocker panel, and the other end of the strip to the longitudinal end of the reinforcement. The strip may therefore extend along a longitudinal direction 40.

Fasteners 14 may include any suitable connecting element. Fasteners 14 may include at least one or more of strips, brackets, rivets, screws, bolts, adhesive and resin. The use of adhesives and resins may reduce vibrations.

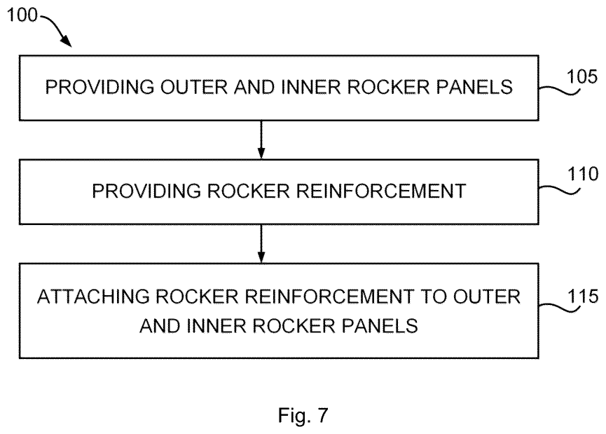

The behavior of rocker assemblies according to the invention, e.g. the rocker assembly 10 of FIG. 2, has been compared to the behavior of several rocker assemblies of the prior art in a Euro NCAP's test in a simplified subsystem. In the compared situations, all the reinforcements were made of extruded aluminum. Two examples of the prior art are shown in FIGS. 5 and 6. The rocker assemblies are for a Volvo XC60 in FIG. 6, and for a Jaguar Land Rover Discovery Sport in FIG. 7. The energy absorbed per section mass of the rocker assembly (abbreviated herein as AE/SM) for these examples of rocker assemblies of the prior art and for the rocker assembly of FIG. 2 are shown in the following table. The section mass (SM) indicates the weight of the rocker assembly 10 per length of a section (longitudinal portion) of the rocker assembly. It is usually expressed in kilograms per meter of section. This length is measured along a longitudinal direction 40. The energy absorbed by the aluminum reinforcement per section mass of the aluminum reinforcement, abbreviated herein as AE(Al)/SM(Al), is also indicated in the table.

TABLE 1

| | | Jaguar | Example of |
|---|---|---|---|
| | Volvo | Land Rover | FIG. 2 |
| AE/SM (kJ · m/kg) | 0.78 | 1.00 | 1.22 |
| AE(Al)/SM(Al) (kJ · m/kg) | 1.30 | 1.17 | 1.56 |

As may be seen in table 1, rocker reinforcements and rocker assemblies according to examples of the present disclosure may lead to an increased energy absorption with respect to rocker assemblies and rocker reinforcements of the prior art.

FIG. 7 illustrates a flowchart of a method 100 for manufacturing a rocker assembly 10 for a vehicle comprising a rocker 20 and a rocker reinforcement 30 attached to the rocker 20. The rocker 20 and the rocker reinforcement 30 may be any of the rockers 20 and rocker reinforcements 30 described throughout this disclosure.

The method 100 comprises, at block 105, providing an outer rocker panel 11 and an inner rocker panel 12. The inner and outer rocker panels may be made of hardened steel, e.g. of an UHSS.

Method 100 further comprises, at block 110, providing a rocker reinforcement, e.g. an aluminum rocker reinforcement 30, with a cross-section according to any of the examples disclosed herein, e.g. as illustrated in the examples of FIGS. 2 and 3. Extrusion may be used in some examples to obtain the rocker reinforcement 30.

In order to obtain an aluminum rocker reinforcement 30 with a cross-section as disclosed herein by extrusion, a die with a cross-sectional profile as disclosed herein may be obtained first. A die may be made of steel. The die may be preheated to a temperature between 400-600° C. to facilitate an even flow of aluminum through the die. Once the die is loaded in an extrusion press, an aluminum billet, which may be preheated in order to make it malleable e.g. to a temperature between 400-600° C., may be pushed against and through the die by a ram. An aluminum extrusion may come out with a desired cross-section. Cooling, aligning and/or cutting of the aluminum extrusion may be additionally performed in order to obtain a rocker reinforcement 30.

Method 100 further includes, at block 115, mechanically attaching the rocker reinforcement 30 to the inner rocker panel 12 and the outer rocker panel 11 such that the upper inner cell contacts the inner rocker panel at a vertical position which is substantially above a battery of the vehicle and the lower inner cell contacts the inner rocker panel at a vertical position which is substantially below a battery of the vehicle when the rocker receives a side impact load.

As explained above, the rocker reinforcement 30 may be attached to an outer rocker panel 11 and/or to an inner rocker panel 12. Fasteners 14 such as steel strips may be used to this end. For example, two or more steel strips may be used. The outer and the inner rocker panels may be joined to one another via the fasteners as well.

“Soft zones”, i.e. areas of lower mechanical strength (areas with lower ultimate tensile strength and yield strength, but potentially with more ductility), may be provided at certain areas of the rocker 20 envisaged as attachment points. For example, soft zones may be provided at the areas of the rocker panels where screws, rivets or similar fasteners may be attached. This may facilitate the attachment between the rocker 20 and the rocker reinforcement 30, e.g, wherein the rocker 20 is made of UHSS and the reinforcement 30 is made of aluminum. Providing soft zones at the attachment points of the rocker may also help to avoid, or at least reduce, concentration of stresses at these points, and possible early rupture or cracking in case of an impact.

Soft zones may additionally or alternatively be provided in one or both rocker panels 11, 12 to improve ductility and energy absorption of the rocker in the regions where these soft zones are created.

The soft zones may for example be created by a partial heat treatment after hot forming die quenching. A laser or an induction heater may be used to locally create areas of different microstructure on the rocker panels.

In some examples, the mounting flanges 13 of the rocker 20 may be formed as soft zones in a press hardened ultra-high strength steel. If the flanges 13 are made as zones that are softer than the remaining of the rocker 20, the flanges 13 may be joined to each other, as well as to the fasteners 14, easier. Stress concentrations at the points of attachment may be avoided, or at least reduced.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1-15. (canceled)

16. A vehicle comprising:
a battery; and
a rocker assembly, the rocker assembly comprising:
a rocker including an outer panel configured to receive a side impact load and an inner panel configured to transmit the side impact load to an inner structure of the vehicle, and
a rocker reinforcement arranged inside the rocker between the inner panel and the outer panel, the rocker reinforcement extending along a longitudinal direction of the rocker and defining a cell structure in a cross-section perpendicular to the longitudinal direction of the rocker along at least a portion of the rocker, wherein
the cell structure comprises a plurality of cells formed by one or more walls forming a closed cross-section, and wherein the plurality of cells comprises an outer portion and an inner portion, the outer portion being closer to the outer panel and the inner portion being closer to the inner panel, wherein
the inner portion comprises an upper inner cell configured to contact the inner panel of the rocker at a vertical position which is substantially higher than the battery and a lower inner cell configured to contact the inner panel at a vertical position which is substantially lower than the battery of the vehicle, and wherein
the inner portion further comprises an empty space between the upper inner cell and the lower inner cell.

17. The vehicle of claim 16, wherein the outer portion comprises at least one cell which is hexagonal in cross-section.

18. The vehicle of claim 17, wherein the outer portion comprises a honeycomb structure.

19. The vehicle of claim 16, wherein the cells of the outer portion are oriented such that at least one wall of one or more of the cells of the outer portion is, in cross-section, substantially parallel to a lateral direction of the rocker, the lateral direction of the rocker being perpendicular to the longitudinal direction and to a vertical direction of the rocker.

20. The vehicle of claim 16, wherein the vehicle comprises a floor and wherein the upper inner cell is elongated and is configured to deviate the side impact load towards the floor.

21. The vehicle of claim 20, wherein the vehicle further comprises a seat cross-member, and wherein the cell structure further comprises a top inner cell arranged above the upper inner cell and which is elongated and is configured to deviate the side impact load towards the seat cross-member.

22. The vehicle of claim 16, wherein a maximum length in cross-section of the upper inner cell and a maximum length in cross-section of the lower inner cell are between one third and two thirds of a maximum width of the rocker reinforcement.

23. The vehicle of claim 16, wherein the upper inner cell, the lower inner cell and one or more cells of the plurality of cells vertically which vertically connect the upper inner cell with the lower inner cell together form an arc-shape in cross-section.

24. The vehicle of claim 16, wherein a mean thickness of the lower inner cell and the upper inner cell is higher than a mean thickness of the outer portion of the rocker reinforcement.

25. The vehicle of claim 16, wherein at least a part of a perimeter of the outer portion of the rocker reinforcement follows a shape of the outer panel of the rocker in cross-section.

26. The vehicle of claim 16, wherein the reinforcement is made of an extruded profile of aluminum alloy.

27. The vehicle of claim 26, wherein the inner panel and the outer panel of the rocker are made of an ultra-high strength steel.

28. A rocker assembly for a vehicle comprising a battery, the rocker assembly comprising:
a rocker including an outer panel made of an ultra high strength steel configured to receive a side impact load and an inner panel made of an ultra high strength steel configured to transmit the side impact load to an inner structure of the vehicle; and
a rocker reinforcement arranged inside the rocker between the inner panel and the outer panel,
the rocker reinforcement extending along a longitudinal direction of the rocker and defining a cell structure in a cross-section perpendicular to the longitudinal direction of the rocker along at least a portion of the rocker, wherein
the cell structure comprises a plurality of cells formed by one or more walls forming a closed cross-section, and wherein the plurality of cells comprises an outer portion and an inner portion, the outer portion being closer to the outer panel and the inner portion being closer to the inner panel, wherein
the inner portion comprises an upper inner cell configured to contact the inner panel of the rocker at a vertical position which is substantially higher than the battery and a lower inner cell configured to contact the inner panel at a vertical position which is substantially lower than the battery of the vehicle, and wherein
the inner portion further comprises an empty space between the upper inner cell and the lower inner cell.

29. The rocker assembly of claim 28, wherein the upper inner cell, the lower inner cell and one or more cells of the plurality of cells vertically which vertically connect the upper inner cell with the lower inner cell together form an arc-shape in cross-section.

30. The rocker assembly of claim 28, wherein a mean thickness of the lower inner cell and the upper inner cell is higher than a mean thickness of the outer portion of the rocker reinforcement.

31. The rocker assembly of claim 30, wherein the reinforcement is made of an extruded profile of aluminum alloy.

32. The rocker assembly of claim 28, comprising two steel strips for attaching the rocker reinforcement to the rocker.

33. The rocker assembly of claim 32, wherein the inner panel is attached to the outer panel at corresponding mounting flanges, and wherein the two steel strips are arranged between the mounting flanges.

34. The rocker assembly of claim 28, wherein the outer portion comprises at least one cell which is hexagonal in cross-section.

35. The rocker assembly of claim 34, wherein the outer portion comprises a honeycomb structure.
